(19) United States
(12) Patent Application Publication
(10) Pub. No.: US 2013/0150276 A1
(43) Pub. Date: Jun. 13, 2013

(54) METHOD OF PROVIDING FAST DRYING AND/OR DELIVERING SHINE ON HARD SURFACES

(71) Applicant: The Procter & Gamble Company, Cincinnati, OH (US)

(72) Inventors: Gloria Dicapua, Ardea (Rome) (IT); Rainer (Anton) Dobrawa, Stuttgart (DE); Marc (Francois Theophile) Evers, Strombeek-Bever (BE); Frank Hulskotter, Bad Duerkheim (DE); Annick (Julia Oscar) Mertens, Bornem (BE); Stefano Scialla, Rome (IT); Patrick (Firmin August) Delplancke, Steenhuize-Wijnhuize (BE)

(73) Assignee: THE PROCTER & GAMBLE COMPANY, Cincinnati, OH (US)

(21) Appl. No.: 13/705,288

(22) Filed: Dec. 5, 2012

Related U.S. Application Data
(60) Provisional application No. 61/568,780, filed on Dec. 9, 2011.

(51) Int. Cl. C11D 3/37

(52) U.S. Cl. CPC C11D 3/3788
USPC 510/219; 510/218; 510/235; 510/220; 510/405; 510/403; 510/475

(57) ABSTRACT

A method of providing fast drying and/or delivering shine on a hard surface with a composition comprising an amphiphilic graft polymer based on water-soluble polyalkylene oxides as a graft base and side chains formed by polymerization of a vinyl ester component, wherein said amphiphilic graft polymer is water-soluble or water-dispersible and has a weight average molar mass of from about 3,000 to about 100,000, and wherein said hard surface is selected from the group consisting of a household hard surface; a dish; flatware; glassware; cutlery; and mixtures thereof.

### FIELD OF THE INVENTION

The present invention relates to a method for providing fast drying and/or delivering shine on a hard surface, such as household hard surfaces, as well as dishes, flatware, glassware, and cutlery, with a hard surface cleaning composition or with a dishwashing detergent composition, respectively.

### BACKGROUND OF THE INVENTION

Hard surfaces, like household hard surfaces, dishes, flatware, glassware, and cutlery, are prone to lose shine after multiple cleaning processes. In addition, consumers prefer cleaning compositions deposited on these surfaces to be dried faster after the cleaning process. Methods of providing fast drying and/or delivering shine on such surfaces have been disclosed in the art. Indeed, to provide fast drying and/or to deliver shine on such surfaces is one of the major targets that consumers pursue in their household cleaning activities. However, it has been found that the currently known cleaning compositions used to clean hard surfaces can be further improved with regard to their shine and/or drying performance, i.e., the fast drying and/or shine delivered to the cleaned hard surfaces.

It is thus an objective of the present invention to provide a method that provides fast drying and/or delivers good shine performance on hard surfaces.

It has been found that the above objective can be met by the use of the composition according to the present invention.

It is an advantage of the composition according to the present invention that it may be used to provide fast drying and/or to deliver shine on hard surfaces made of a variety of materials like glazed and non-glazed ceramic tiles, enamel, stainless steel, Inox®, Formica®, vinyl, no-wax vinyl, linoleum, melamine, glass, and plastics.

### SUMMARY OF THE INVENTION

The present invention relates to a method of providing fast drying and/or delivering shine on a hard surface with a composition comprising an amphiphilic graft polymer based on water-soluble polyalkylene oxides as a graft base and side chains formed by polymerization of a vinyl ester component, wherein said amphiphilic graft polymer is water-soluble or water-dispersible and has a weight average molar mass of from about 3,000 to about 100,000, and wherein said hard surface is selected from the group consisting of a household hard surface; dishes; flatware; glassware; cutlery and mixtures thereof.

### DETAILED DESCRIPTION OF THE INVENTION

### The Composition

The composition according to the present invention is designed to provide fast drying and/or to deliver shine on hard surfaces.

The composition according to the present invention may be in a form selected from the group consisting of a liquid; a gel; and a solid. Preferably, the composition according to the present invention is a liquid or gel composition.

The composition of the present invention may be a hard surface cleaning composition, a hand dishwashing detergent composition, or an automatic dishwashing detergent composition. In a preferred embodiment, the hard surface cleaning composition is used to provide fast drying and/or to deliver shine on household hard surfaces. In an alternatively preferred embodiment, the hand dishwashing detergent composition is used to provide fast drying and/or to deliver shine on dishes, flatware, glassware, cutlery, etc. in a hand dishwashing cleaning operation. In another preferred embodiment, the automatic dishwashing composition is used to provide fast drying and/or to deliver shine on dishes, flatware, glassware, cutlery, etc. in an automatic dishwashing operation.

In the preferred embodiment wherein the composition is a hard surface cleaning composition, the composition comprises from about 70% to about 99%, preferably from about 75% to about 95%, and more preferably from about 80% to about 95% by weight of the total composition of water.

Alternatively, in the preferred embodiment wherein the composition is a hand dishwashing detergent composition, the composition comprises from about 30% to about 95%, preferably from about 40% to about 80%, and more preferably from about 50% to about 75% by weight of the total composition of water.

In the preferred embodiment wherein the composition is a hard surface cleaning composition, the composition has a pH from about 2 to about 14, preferably from about 2 to about 10, more preferably from about 2 to about 9.5, and even more preferably from about 2.1 to about 8, as is measured at 25° C. In the preferred embodiment wherein the composition is a hand dishwashing detergent composition, the composition has a pH from about 3 to about 14, preferably from about 6 to about 13, most preferably from about 8 to about 11.

In the preferred embodiment wherein the composition is a hard surface cleaning composition, the composition has a water-like viscosity. By “water-like viscosity” it is meant herein a viscosity that is close to that of water. Preferably, the composition herein has a viscosity of up to about 50 cps, more preferably from about 0 cps to about 30 cps, yet more preferably from about 0 cps to about 20 cps, and most preferably from about 0 cps to about 10 cps at 60 rpm and 20° C., when measured with a Brookfield digital viscometer model DV II, with spindle 2.

In the preferred embodiment wherein the composition is a hard surface cleaning composition, the composition of the present invention is a thickened composition. Thus, the composition herein preferably has a viscosity of from about 50 cps to about 5000 cps, more preferably from about 50 cps to about 2000 cps, yet more preferably from about 50 cps to about 1000 cps, and most preferably from about 50 cps to about 500 cps at 20 s⁻¹ and 20° C., when measured with a Rheometer, model AR 1000 (Supplied by TA Instruments) with a 4 cm conic spindle in stainless steel, 2° angle (linear increment from 0.1 to 100 sec⁻¹ in maximum 8 minutes). Preferably, the thickened composition according to the embodiment is a shear-thinning composition. The thickened composition herein preferably comprises a thickener, more preferably a polysaccharide polymer thickener, still more preferably a gum-type polysaccharide polymer thickener, and most preferably a Xanthan gum thickener.

Alternatively, in the preferred embodiment wherein the composition is a hand dishwashing detergent composition, the composition preferably has a viscosity from about 50 cps to 2000 cps, yet more preferably from about 100 cps to about 1500 cps, and most preferably from about 500 cps to about 1300 cps at 20 s⁻¹ and 20° C.

### Amphiphilic Graft Polymer

The amphiphilic graft polymer is based on water-soluble polyalkylene oxides as a graft base and side chains formed by polymerization of a vinyl ester component. The amphiphilic graft polymer is water-soluble or water-dispersible and has a weight average molar mass (M_{w}) of from about 3,000 to about 100,000, preferably from about 6,000 to about 45,000, and most preferably from about 8,000 to about 30,000. The weight average molar mass Mw is defined by the following expression

$$\text{?} = \frac{{\sum }_{i} {N}_{i} \text{?}}{{\sum }_{i} {N}_{i} {M}_{i}}$$

$$\text{?} \text{indicates text missing or illegible when filed}$$

Where Ni is the number of polymer molecules with molecular weight Mi.

Preferably, the amphiphilic graft polymer is soluble in water or in water/alcohol mixtures (for example a 25% by weight solution of diethylene glycol monobutyl ether in water). Preferably, the amphiphilic graft polymer herein has a low cloud point which, for the amphiphilic graft polymer soluble in water at up to 50° C., is less than or equal to about 95° C., or less than or equal to about 85° C., or less than or equal to about 75° C., and, in 25% by weight diethylene glycol monobutyl ether, less than or equal to about 90° C., preferably from about 45 to about 85° C.

In a preferred embodiment, the amphiphilic graft polymer has low degree of branching (degree of grafting). Preferably, the amphiphilic graft polymer herein has, on average, based on the reaction mixture obtained, not more than about 1 graft site, preferably not more than about 0.6 graft site, more preferably not more than about 0.5 graft site and most preferably not more than about 0.4 graft site per about 50 alkylene oxide units. The amphiphilic graft polymer herein preferably comprises, on average, based on the reaction mixture obtained, preferably at least about 0.05, in particular at least about 0.1 graft site per about 50 alkylene oxide units. The degree of branching can be determined, for example, by means of ¹³C NMR spectroscopy from the integrals of the signals of the graft sites and the —CH₂-groups of the polyalkylene oxide.

Preferably, in accordance with the low degree of branching, the molar ratio of grafted to ungrafted alkylene oxide units in the amphiphilic graft polymers is from about 0.002 to about 0.05, preferably from about 0.002 to about 0.035, more preferably from about 0.003 to about 0.025, and even more preferably from about 0.004 to about 0.02.

Preferably, the composition of the present invention comprises from about 0.01% to about 10%, preferably from about 0.1% to about 5%, more preferably from about 0.2% to about 3%, and even more preferably from about 0.3% to about 2% by weight of the total composition of the amphiphilic graft polymer.

In some embodiments, the amphiphilic graft polymer features a narrow molar mass distribution and hence a polydispersity M_{w}/Mₙ of generally less than or equal to about 3, or less than or equal to about 2.5, or less than or equal to about 2.3. In some embodiments, its polydispersity M_{w}/Mₙ is in the range from about 1.5 to about 2.2. The polydispersity of the amphiphilic graft polymer can be determined, for example, by gel permeation chromatography using narrow-distribution polymethyl methacrylates as the standard. In the above expression for polydispersity and throughout the rest of this description, Mw is the weight average molar mass as previously defined, and Mn is the number average molar mass defined by the following expression

$$\text{?} = \frac{{\sum }_{i} {N}_{i} {M}_{i}}{{\sum }_{i} {N}_{i}}$$

$$\text{?} \text{indicates text missing or illegible when filed}$$

where Ni is the number of polymer molecules with molecular weight Mi.

Other embodiments of the amphiphilic graft polymer may also have only a low content of ungrafted polyvinyl ester. In general, the amphiphilic graft polymer comprises less than or equal to about 10%, preferably less than or equal to about 7.5%, and more preferably less than or equal to about 5% by weight of ungrafted polyvinyl ester.

Some embodiments of the amphiphilic graft polymer have:

(A) from about 20% to about 70% by weight of a water-soluble polyalkylene oxide as a graft base and
(B) side chains formed by free-radical polymerization of from about 30% to about 80% by weight of a vinyl ester component composed of:
(B1) from about 70% to 100% by weight of vinyl acetate and/or vinyl propionate and
(B2) from 0% to about 30% by weight of a further ethylenically unsaturated monomer in the presence of (A).
Preferred embodiments of the amphiphilic graft polymer have:
(A) from about 30% to about 60% by weight of a water-soluble polyethylene oxide as a graft base and
(B) side chains formed by free-radical polymerization of from about 40% to about 70% by weight of a vinyl ester compound composed of
(B1) from about 70% to about 100% by weight of vinyl acetate and/or vinyl propionate and
(B2) from about 0% to about 30% by weight of a further ethylenically unsaturated monomer in the presence of (A).

Other embodiments comprise from about 25% to about 60% by weight of the graft base (A) and from about 40% to about 75% by weight of the polyvinyl ester component (B).

Water-soluble polyalkylene oxides suitable for forming the graft base (A) are in principle all polymers based on C₂-C₄-alkylene oxides which comprise at least about 50%, or at least about 60%, or at least about 75% by weight of ethylene oxide in copolymerized form. The polyalkylene oxides (A) may be the corresponding polyalkylene glycols in free form, i.e. with OH end groups, but they may also be capped at one or both end groups. Suitable end groups are, for example, C₁-C₂₅-alkyl, phenyl, and C₁-C₁₄-alkylphenyl groups.

Non-limiting examples of particularly suitable polyalkylene oxides (A) include:

(A1) polyethylene glycols which may be capped at one or both end groups, especially by C₁-C₂₅-alkyl groups, but are preferably not etherified, and have number average molar mass Mₙ of preferably from about 1500 to about 20,000, more preferably from about 2500 to about 15,000;
(A2) copolymers of ethylene oxide and propylene oxide and/or butylene oxide with an ethylene oxide content of at least about 50% by weight, which may likewise be capped at one or both end groups, for example by C₁-C₂₅-alkyl groups, but are preferably not etherified, and have number average molar masses Mₙ of preferably from about 1500 to about 20,000, more preferably from about 2500 to about 15,000;
(A3) chain-extended products having mean molar masses of from about 2500 to about 20,000, which are obtainable by reacting polyethylene glycols (A1) having number average molar masses Mₙ of from about 200 to about 5000 or copolymers (A2) having number average molar masses Mₙ of from about 200 to about 5000 with C₂-C₁₂-dicarboxylic acids or -dicarboxylic esters or C₆-C₁₈-diisocyanates.

In some embodiments, the graft bases (A) are polyethylene glycols (A1). The side chains of the inventive graft polymers are formed by polymerization of a vinyl ester component (B) in the presence of the graft base (A).

The vinyl ester component (B) may comprise of (B1) vinyl acetate, or vinyl propionate, or mixtures thereof. In some embodiments some preference may be given to vinyl acetate as the vinyl ester component (B). However, the side chains of the graft polymer can also be formed by copolymerizing vinyl acetate and/or vinyl propionate (B1) and a further ethylenically unsaturated monomer (B2). The fraction of monomer (B2) in the vinyl ester component (B) may be up to about 30% by weight, which corresponds to a content in the graft polymer of (B2) of about 24% by weight.

Suitable comonomers (B2) are, for example, monoethylenically unsaturated carboxylic acids and dicarboxylic acids and their derivatives, such as esters, amides and anhydrides, and styrene. It is also possible to use mixtures of different comonomers. Specific, non-limiting examples include (meth)acrylic acid, C₁-C₁₂-alkyl and hydroxy-C₂-C₁₂-alkyl esters of (meth)acrylic acid, (meth)acrylamide, N—C₁-C₁₂-alkyl(meth)acrylamide, N,N-di(C₁-C₆-alkyl)(meth)acrylamide, maleic acid, maleic anhydride and mono(C₁-C₁₂-alkyl)esters of maleic acid. Some monomers (B2) are the C₁-C₈-alkyl esters of (meth)acrylic acid and hydroxyethyl acrylate. In some embodiments, particular preference may be given to C₁-C₄-alkyl esters of (meth)acrylic acid. Some embodiment may use methyl acrylate, ethyl acrylate, or n-butyl acrylate. When the amphiphilic graft polymer comprises the monomers (B2) as a constituent of the vinyl ester component (B), the content of graft polymers in (B2) may be from about 0.5% to about 20% by weight, or from about 1% to about 15% by weight, or from about 2% to about 10% by weight.

One method of preparing the amphiphilic graft polymer comprises the steps of: polymerizing a vinyl ester component (B) composed of vinyl acetate and/or vinyl propionate (B1) and, if desired, a further ethylenically unsaturated monomer (B2), in the presence of a water-soluble polyalkylene oxide (A), a free radical-forming initiator (C) and, if desired, up to about 40% by weight, based on the sum of components (A), (B) and (C), of an organic solvent (D), at a mean polymerization temperature at which the initiator (C) has a decomposition half-life of from about 40 to about 500 min, in such a way that the fraction of unconverted graft monomer (B) and initiator (C) in the reaction mixture is constantly kept in a quantitative deficiency relative to the polyalkylene oxide (A).

Suitable amphiphilic graft polymers herein are commercially available under the trade name Sokalan® HP22 from BASF.

Without intending to be limited by theory, it is believed that the amphiphilic graft polymer acts like an oversized surfactant and is highly surface active. Thus, the amphiphilic graft polymer deposits on hard surfaces upon cleaning of such surfaces with the composition according to the present invention and changes the surface properties of such hard surfaces. This surface modification leads to water spreading and faster draining. In this way, the amphiphilic graft polymer expedites the drying of the cleaned hard surfaces and/or delivers shine performance.

### Optional Ingredients

The composition according to the present invention may comprise a variety of optional ingredients depending on the technical benefit aimed for and the surfaces treated.

Suitable optional ingredients for use herein include a surfactant or a mixture thereof; an alkaline material or a mixture thereof; an inorganic or organic acid and salt thereof or a mixture thereof; a buffering agent or a mixture thereof; a surface modifying polymer or a mixture thereof; a cleaning polymer or a mixture thereof; a peroxygen bleach or a mixture thereof; a radical scavenger or a mixture thereof; a chelating agent or a mixture thereof; a perfume or a mixture thereof; a dye or a mixture thereof; a hydrotrope or a mixture thereof; a polymeric suds stabilizer or a mixture thereof; a diamine or a mixture thereof; and mixtures thereof.

### Surfactant

Surfactants may be desired herein as they further contribute to the cleaning performance and/or shine benefit of the compositions of the present invention.

Surfactant—hard surface cleaning composition

In the preferred embodiment wherein the composition is a hard surface cleaning composition, the composition comprises a surfactant or a mixture thereof as one preferred, but optional ingredient to provide cleaning capabilities. Suitable surfactant is selected from the group consisting of an anionic surfactant or a mixture thereof; a nonionic surfactant or a mixture thereof; an amphoteric surfactant or a mixture thereof; a zwitterionic surfactant or a mixture thereof; and mixtures thereof.

Preferably, in the preferred embodiment wherein the composition is a hard surface cleaning composition, the composition comprises from about 1% to about 60%, preferably from about 5% to about 30%, and more preferably from about 10% to about 25% by weight of the total composition of a surfactant.

### Nonionic Surfactant

Suitable nonionic surfactant for use in the preferred embodiment wherein the composition is a hard surface cleaning composition can be alkoxylated alcohol nonionic surfactant, which can be readily made by condensation processes which are well-known in the art. However, a great variety of such alkoxylated alcohols, especially ethoxylated and/or propoxylated alcohols, are conveniently commercially available. Surfactant catalogs are available which list a number of surfactants, including nonionics.

Accordingly, preferred alkoxylated alcohols for use herein are nonionic surfactants according to the formula R¹O(E)ₑ(P)ₚH where R¹ is a hydrocarbon chain of from about 2 to about 24 carbon atoms, E is ethylene oxide, P is propylene oxide, and e and p which represent the average degree of, respectively ethoxylation and propoxylation, are of from about 0 to about 24 (with the sum of e+p being at least 1). Preferably, the hydrophobic moiety of the nonionic compound can be a primary or secondary, straight or branched alcohol having from about 8 to about 24 carbon atoms.

In some embodiments, preferred nonionic surfactants for use in the preferred embodiment wherein the composition is a hard surface cleaning composition are the condensation products of ethylene oxide and/or propylene oxide with an alcohol having a straight or branched alkyl chain, having from about 6 to about 22 carbon atoms, wherein the degree of alkoxylation (ethoxylation and/or propoxylation) is from about 1 to about 15, preferably from about 5 to about 12. Such suitable nonionic surfactants are commercially available from Shell, for instance, under the trade name Neodol® or from BASF under the trade name Lutensol®.

### Anionic Surfactant

The presence of an anionic surfactant contributes to the cleaning of the composition herein. More generally, the presence of an anionic surfactant in the hard surface cleaning composition according to the present invention allows to lower the surface tension and to improve the wettability of the surfaces being treated with the hard surface cleaning composition of the present invention. Furthermore, the anionic surfactant, or a mixture thereof, helps solubilize the soils in the compositions of the present invention.

Suitable anionic surfactant in the preferred embodiment wherein the composition is a hard surface cleaning composition can be all those commonly known by those skilled in the art. Preferably, the anionic surfactant includes an alkyl sulphonate or a mixture thereof; an alkyl aryl sulphonate or a mixture thereof; and mixtures thereof.

Particularly suitable linear alkyl sulphonate includes C₈ sulphonate like Witconate NAS 8® commercially available from Witco.

Other anionic surfactants useful herein include a salt (including, for example, sodium, potassium, ammonium, and substituted ammonium salts such as mono-, di- and triethanolamine salts) of soap, an alkyl sulphate, an alkyl aryl sulphate, an alkyl alkoxylated sulphate, a C₈-C₂₄ olefinsulfonate, a sulphonated polycarboxylic acid prepared by sulphonation of the pyrolyzed product of alkaline earth metal citrates, e.g., as described in British patent specification No. 1,082,179; an alkyl ester sulfonate such as C₁₄₋₁₆ methyl ester sulfonate; an acyl glycerol sulfonate, an alkyl phosphate, an isethionate such as an acyl isethionate, a N-acyl taurate, an alkyl succinamate, an acyl sarcosinate, a sulfate of alkylpolysaccharide such as an sulfate of alkylpolyglucoside (the nonionic nonsulfated compounds being described below), an alkyl polyethoxy carboxylate such as those of the formula R²O(CH₂CH₂O)ₖCH₂COO-M⁺ wherein R² is a C₈-C₂₂ alkyl, k is an integer from about 0 to about 10, and M is a soluble salt-forming cation. A resin acid and a hydrogenated resin acid are also suitable, such as a rosin, a hydrogenated rosin, and a resin acid and a hydrogenated resin acid present in or derived from tall oil. Further examples are given in “Surface Active Agents and Detergents” (Vol. I and II by Schwartz, Perry and Berch). A variety of such surfactants are also generally disclosed in U.S. Pat. No. 3,929,678, issued Dec. 30, 1975 to Laughlin, et al. at Column 23, line 58 through Column 29, line 23.

### Zwitterionic Surfactant

Suitable zwitterionic surfactant in the preferred embodiment wherein the composition is a hard surface cleaning composition contains both basic and acidic groups which form an inner salt giving both cationic and anionic hydrophilic groups on the same molecule at a relatively wide range of pH's. The typical cationic group is a quaternary ammonium group, although other positively charged groups like phosphonium, imidazolium and sulfonium groups can be used. The typical anionic hydrophilic groups are carboxylate and sulfonate, although other groups like sulfate, phosphonate, and the like can be used.

Some common examples of zwitterionic surfactants (i.e. betaine/sulphobetaine) are described in U.S. Pat. Nos. 2,082,275, 2,702,279 and 2,255,082.

For example coconut dimethyl betaine is commercially available from Seppic under the trade name of Amonyl 265®. Lauryl betaine is commercially available from Albright & Wilson under the trade name Empigen BB/L®. A further example of betaine is lauryl-imino-dipropionate commercially available from Rhodia under the trade name Mirataine H2C-HA®.

Particularly preferred zwitterionic surfactants for use in the preferred embodiment wherein the composition is a hard surface cleaning composition is the sulfobetaine surfactant as it delivers optimum soap scum cleaning benefits.

Examples of particularly suitable sulfobetaine surfactant include tallow bis(hydroxyethyl) sulphobetaine and cocoamido propyl hydroxy sulphobetaine which are commercially available from Rhodia and Witco, under the trade name of Mirataine CBS® and Rewoteric AM CAS 15® respectively.

### Amphoteric Surfactant

Suitable amphoteric surfactant in the preferred embodiment wherein the composition is a hard surface cleaning composition includes the amine oxide. Examples of amine oxides for use herein are for instance coconut dimethyl amine oxide and C₁₂-C₁₆ dimethyl amine oxide. Said amine oxides may be commercially available from Clariant, Stepan, and AKZO (under the trade name Aromox®). Other suitable amphoteric surfactants for the purpose of the invention are the phosphine or sulfoxide surfactants.

### Surfactant—Hand Dishwashing Detergent Composition

Similarly, in the preferred embodiment wherein the composition is a hand dishwashing detergent composition, the composition also comprises a surfactant or a mixture thereof as one preferred, but optional ingredient to provide cleaning capabilities. Suitable surfactant is selected from the group consisting of an anionic surfactant or a mixture thereof; a nonionic surfactant or a mixture thereof; a cationic surfactant or a mixture thereof; an amphoteric surfactant or a mixture thereof; a zwitterionic surfactant or a mixture thereof; and mixtures thereof.

Preferably, in the preferred embodiment wherein the composition is a hand dishwashing detergent composition, the composition may comprise from about 5% to about 80%, preferably from about 10% to about 60%, more preferably from about 12% to about 45% by weight of the total composition of a surfactant. In preferred embodiments, the surfactant herein has an average branching of the alkyl chain(s) of more than about 10%, preferably more than about 20%, more preferably more than about 30%, and even more preferably more than about 40% by weight of the total surfactant.

### Nonionic Surfactant

In the preferred embodiment wherein the composition is a hand dishwashing detergent composition, the composition comprises a nonionic surfactant. More preferably, the weight ratio of total surfactant to nonionic surfactant is from about 2 to about 10, preferably from about 2 to about 7.5, more preferably from about 2 to about 6.

Preferably, the nonionic surfactant is comprised in a typical amount of from about 2% to about 40%, preferably from about 3% to about 30% by weight of the hand dishwashing detergent composition, and preferably from about 3 to about 20% by weight of the total composition.

Suitable nonionic surfactants include the condensation products of an aliphatic alcohol with from about 1 to about 25 moles of ethylene oxide per mole of alcohol. The alkyl chain of the aliphatic alcohol can either be straight or branched, primary or secondary, and generally contains from about 8 to about 22 carbon atoms. Particularly preferred are the condensation products of alcohols having an alkyl group containing from about 8 to about 18 carbon atoms, preferably from about 9 to about 15 carbon atoms, with from about 2 to about 18 moles, preferably from about 2 to about 15, more preferably from about 5 to about 12 moles of ethylene oxide per mole of alcohol.

Also suitable are alkylpolyglycosides having the formula R³⁰(CₙH₂ₙO)ₜ(glycosyl)_{z} (formula (III)), wherein R³ of formula (III) is selected from the group consisting of an alkyl or a mixture thereof; an alkyl-phenyl or a mixture thereof; a hydroxyalkyl or a mixture thereof; a hydroxyalkylphenyl or a mixture thereof; and mixtures thereof, in which the alkyl group contains from about 10 to about 18, preferably from about 12 to about 14 carbon atoms; n of formula (III) is about 2 or about 3, preferably about 2; t of formula (III) is from about 0 to about 10, preferably about 0; and z of formula (III) is from about 1.3 to about 10, preferably from about 1.3 to about 3, most preferably from about 1.3 to about 2.7. The glycosyl is preferably derived from glucose. Also suitable are alkyl glycerol ether and sorbitan ester.

Also suitable is fatty acid amide surfactant having the formula (IV):

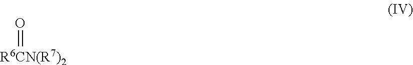

wherein R⁶ of formula (IV) is an alkyl group containing from about 7 to about 21, preferably from about 9 to about 17, carbon atoms, and each R⁷ of formula (IV) is selected from the group consisting of hydrogen; a C₁-C₄ alkyl or a mixture thereof; a C₁-C₄ hydroxyalkyl or a mixture thereof; and a —(C₂H₄O)_{y}H or a mixture thereof, where y of formula (IV) varies from about 1 to about 3. Preferred amide can be a C₈-C₂₀ ammonia amide, a monoethanolamide, a diethanolamide, and an isopropanolamide.

Other preferred nonionic surfactants in the preferred embodiment wherein the composition is a hand dishwashing detergent composition are the mixture of nonyl (C₉), decyl (C₁₀) undecyl (C₁₁) alcohols modified with, on average, about 5 ethylene oxide (EO) units such as the commercially available Neodol 91-5® or the Neodol 91-8® that is modified with on average about 8 EO units. Also suitable are the longer alkyl chains ethoxylated nonionics such as C₁₂ or C₁₃ modified with 5 EO (Neodol 23-50). Neodol® is a Shell tradename. Also suitable is the C₁₂ or C₁₄ alkyl chain with 7 EO, commercially available under the trade name Novel 1412-7® (Sasol) or the Lutensol A 7 N® (BASF).

Preferred branched nonionic surfactants are the Guerbet C₁₀ alcohol ethoxylates with 5 EO such as Ethylan 1005, Lutensol XP 50® and the Guerbet C₁₀ alcohol alkoxylated nonionics (modified with EO and PO(propyleneoxyde)) such as the commercially available Lutensol XL® series (X150, XL70, etc). Other branching also includes oxo branched nonionic surfactants such as the Lutensol ON 50® (5 EO) and Lutensol ON700 (7 EO). Other suitable branched nonionics are the ones derived from the isotridecyl alcohol and modified with ethyleneoxide such as the Lutensol TO7® (7EO) from BASF and the Marlipal O 13/70® (7 EO) from Sasol. Also suitable are the ethoxylated fatty alcohols originating from the Fisher & Tropsch reaction comprising up to about 50% branching (about 40% methyl (mono or bi) about 10% cyclohexyl) such as those produced from the Safol® alcohols from Sasol; ethoxylated fatty alcohols originating from the oxo reaction wherein at least 50 wt % of the alcohol is C₂ isomer (methyl to pentyl) such as those produced from the Isalchem® alcohols or Lial® alcohols from Sasol; the ethoxylated fatty alcohols originating from the modified oxo reaction wherein at least about 15% by weight of the alcohol is C₂ isomer (methyl to pentyl) such as those produced from the Neodol® alcohols from Shell.

### Anionic Surfactant

Suitable anionic surfactants in the preferred embodiment wherein the composition is a hand dishwashing detergent composition can be a sulfate, a sulfosuccinate, a sulfoacetate, and/or a sulfonate; preferably an alkyl sulfate and/or an alkyl ethoxy sulfate; more preferably a combination of an alkyl sulfate and/or an alkyl ethoxy sulfate with a combined ethoxylation degree less than about 5, preferably less than about 3, more preferably less than about 2.

Sulphate or sulphonate surfactant is typically present at a level of at least about 5%, preferably from about 5% to about 40%, and more preferably from about 15% to about 30%, and even more preferably at about 15% to about 25% by weight of the hand dishwashing detergent composition.

Suitable sulphate or sulphonate surfactants for use in the preferred embodiment wherein the composition is a hand dishwashing detergent composition include water-soluble salts or acids of C₁₀-C₁₄ alkyl or hydroxyalkyl, sulphate or sulphonates. Suitable counterions include hydrogen, alkali metal cation or ammonium or substituted ammonium, but preferably sodium. Where the hydrocarbyl chain is branched, it preferably comprises a C₁₋₄ alkyl branching unit. The average percentage branching of the sulphate or sulphonate surfactant is preferably greater than about 30%, more preferably from about 35% to about 80%, and most preferably from about 40% to about 60% of the total hydrocarbyl chain.

The sulphate or sulphonate surfactants may be selected from a C₁₁-C₁₈ alkyl benzene sulphonate (LAS), a C₈-C₂₀ primary, a branched-chain and random alkyl sulphate (AS); a C₁₀-C₁₈ secondary (2,3) alkyl sulphate; a C₁₀-C₁₈ alkyl alkoxy sulphate (AEₓS) wherein preferably x is from 1-30; a C₁₀-C₁₈ alkyl alkoxy carboxylate preferably comprising about 1-5 ethoxy units; a mid-chain branched alkyl sulphate as discussed in U.S. Pat. No. 6,020,303 and U.S. Pat. No. 6,060,443; a mid-chain branched alkyl alkoxy sulphate as discussed in U.S. Pat. No. 6,008,181 and U.S. Pat. No. 6,020,303; a modified alkylbenzene sulphonate (MLAS) as discussed in WO 99/05243, WO 99/05242, WO 99/05244, WO 99/05082, WO 99/05084, WO 99/05241, WO 99/07656, WO 00/23549, and WO 00/23548; a methyl ester sulphonate (MES); and an alpha-olefin sulphonate (AOS).

The paraffin sulphonate may be monosulphonate or disulphonate and usually are mixtures thereof, obtained by sulphonating a paraffin of about 10 to about 20 carbon atoms. Preferred sulphonates are those of C₁₂₋₁₈ carbon atoms chains and more preferably they are C₁₄₋₁₇ chains. Paraffin sulphonates that have the sulphonate group(s) distributed along the paraffin chain are described in U.S. Pat. No. 2,503,280; U.S. Pat. No. 2,507,088; U.S. Pat. No. 3,260,744; U.S. Pat. No. 3,372,188 and in DE 735 096.

Also suitable are the alkyl glyceryl sulphonate surfactant and/or alkyl glyceryl sulphate surfactant described in the Procter & Gamble patent application WO06/014740: A mixture of oligomeric alkyl glyceryl sulfonate and/or sulfate surfactant selected from a dimmer or a mixture thereof; a trimer or a mixture thereof; a tetramer or a mixture thereof; a pentamer or a mixture thereof; a hexamer or a mixture thereof; a heptamer or a mixture thereof; and mixtures thereof; wherein the alkyl glyceryl sulfonate and/or sulfate surfactant mixture comprises from about 0% to about 60% by weight of the monomers.

Other suitable anionic surfactants are alkyl, preferably dialkyl sulfosuccinate and/or sulfoacetate. The dialkyl sulfosuccinate may be a C₆₋₁₅ linear or branched dialkyl sulfosuccinate. The alkyl moiety may be symmetrical (i.e., the same alkyl moieties) or asymmetrical (i.e., different alkyl moiety.es). Preferably, the alkyl moiety is symmetrical.

Most common branched anionic alkyl ether sulphates are obtained via sulfation of a mixture of the branched alcohols and the branched alcohol ethoxylates. Also suitable are the sulfated fatty alcohols originating from the Fischer & Tropsh reaction comprising up to about 50% branching (about 40% methyl (mono or bi) about 10% cyclohexyl) such as those produced from the safol alcohols from Sasol; sulfated fatty alcohols originating from the oxo reaction wherein at least about 50% by weight of the alcohol is C₂ isomer (methyl to pentyl) such as those produced from the Isalchem® alcohols or Lial® alcohols from Sasol; the sulfated fatty alcohols originating from the modified oxo reaction wherein at least about 15% by weight of the alcohol is C₂ isomer (methyl to pentyl) such as those produced from the Neodol® alcohols from Shell.

Zwitterionic Surfactant and Amphoteric Surfactant The zwitterionic and amphoteric surfactants in the preferred embodiment wherein the composition is a hand dishwashing detergent composition can be comprised at a level of from about 0.01% to about 20%, preferably from about 0.2% to about 15%, more preferably from about 0.5% to about 10% by weight of the hand dishwashing detergent composition. The hand dishwashing detergent composition preferably further comprises an amine oxide and/or a betaine.

Most preferred amine oxides are coconut dimethyl amine oxide or coconut amido propyl dimethyl amine oxide. Amine oxide may have a linear or mid-branched alkyl moiety. Typical linear amine oxides include water-soluble amine oxide containing one R⁴ C₈₋₁₈ alkyl moiety and 2 R⁵ and R⁸ moieties selected from the group consisting of a C₁₋₃ alkyl group and a mixtures thereof; and a C₁₋₃ hydroxyalkyl group and a mixture thereof. Preferably amine oxide is characterized by the formula R⁴—N(R⁵)(R⁸)→O wherein R⁴ is a C₈₋₁₈ alkyl and R⁵ and R⁸ are selected from the group consisting of a methyl; an ethyl; a propyl; an isopropyl; a 2-hydroxethyl; a 2-hydroxypropyl; and a 3-hydroxypropyl. The linear amine oxide surfactant, in particular, may include a linear C₁₀-C₁₈ alkyl dimethyl amine oxide and a linear C₈-C₁₂ alkoxy ethyl dihydroxy ethyl amine oxide. Preferred amine oxides include linear C₁₀, linear C₁₀-C₁₂, and linear C₁₂-C₁₄ alkyl dimethyl amine oxides.

As used herein “mid-branched” means that the amine oxide has one alkyl moiety having n₁ carbon atoms with one alkyl branch on the alkyl moiety having n₂ carbon atoms. The alkyl branch is located on the α carbon from the nitrogen on the alkyl moiety. This type of branching for the amine oxide is also known in the art as an internal amine oxide. The total sum of n₁ and n₂ is from about 10 to about 24 carbon atoms, preferably from about 12 to about 20, and more preferably from about 10 to about 16. The number of carbon atoms for the one alkyl moiety (n₁) should be approximately the same number of carbon atoms as the one alkyl branch (n₂) such that the one alkyl moiety and the one alkyl branch are symmetric. As used herein, “symmetric” means that |n₁−n₂| is less than or equal to about 5, preferably about 4, most preferably from about 0 to about 4 carbon atoms in at least about 50 wt %, more preferably at least about 75 wt % to about 100 wt % of the mid-branched amine oxide for use herein.

The amine oxide further comprises two moieties, independently selected from a C₁₋₃ alkyl; a C₁₋₃ hydroxyalkyl group; or a polyethylene oxide group containing an average of from about 1 to about 3 ethylene oxide groups. Preferably the two moieties are selected from a C₁₋₃ alkyl, more preferably both are selected as a C₁ alkyl.

Other suitable surfactants include a betaine such an alkyl betaine, an alkylamidobetaine, and amidazoliniumbetaine, a sulfobetaine (INCI Sultaines), as well as a phosphobetaine, and preferably meets formula I:

R^{1′}—[CO—X(CH₂)ⱼ]_{g}—N⁺(R^{2′})(R^{3′})—(CH₂)_{f}—[CH(OH)—CH₂]^{h}—Y— (I)

wherein
R^{1′} is a saturated or unsaturated C₆₋₂₂ alkyl residue, preferably a C₈₋₁₈ alkyl residue, in particular a saturated C₁₀₋₁₆ alkyl residue, for example a saturated C₁₂₋₁₄ alkyl residue;
X is NH, NR^{4′} with C₁₋₄ alkyl residue R^{4′}, O or S,
j is a number from about 1 to about 10, preferably from about 2 to about 5, in particular about 3,
g is about 0 or about 1, preferably about 1,
R^{2′}, R^{3′} are independently a C₁₋₄ alkyl residue, potentially hydroxy substituted by such as a hydroxyethyl, preferably by a methyl.
f is a number from about 1 to about 4, in particular about 1, 2 or 3,
h is about 0 or 1, and
Y is selected from COO, SO₃, OPO(OR^{5′})O or P(O)(OR^{5′})O, whereby R^{5′} is a hydrogen atom H or a C₁₋₄ alkyl residue.

Preferred betaines are the alkyl betaine of the formula (Iₐ), the alkyl amido betaine of the formula (I_{b}), the sulfo betaine of the formula (I_{c}), and the Amido sulfobetaine of the formula (I_{d});

R^{1′}—N⁺(CH₃)₂—CH₂COO⁻ (Iₐ)

R^{1′}—CO—NH(CH₂)₃—N⁺(CH₃)₂—CH₂COO⁻ (I_{b})

R^{1′}—N⁺(CH₃)₂—CH₂CH(OH)CH₂SO₃— (I_{c})

R^{1′}—CO—NH—(CH₂)₃—N⁺(CH₃)₂—CH₂CH(OH)CH₂SO₃⁻ (I_{d})

in which R^{1′ has the same meaning as in formula I. Particularly preferred betaines are the carbobetaine, wherein Y}⁻ is [COO⁻], in particular the carbobetaine of formula (Iₐ) and (I_{b}), more preferred are the alkylamidobetaine of the formula (I_{b}).

Examples of suitable betaines and sulfobetaines are the following (designated in accordance with INCI): almondamidopropyl of betaine, apricotamidopropyl betaine, avocadamidopropyl of betaine, babassuamidopropyl of betaine, behenamidopropyl betaine, behenyl of betaine, betaine, canolamidopropyl betaine, capryl/capramidopropyl betaine, carnitine, cetyl of betaine, cocamidoethyl of betaine, cocamidopropyl betaine, cocamidopropyl hydroxysultaine, coco betaine, coco hydroxysultaine, coco/oleamidopropyl betaine, coco sultaine, decyl of betaine, dihydroxyethyl oleyl glycinate, dihydroxyethyl soy glycinate, dihydroxyethyl stearyl glycinate, dihydroxyethyl tallow glycinate, dimethicone propyl of PG-betaine, drucamidopropyl hydroxysultaine, hydrogenated tallow of betaine, isostearamidopropyl betaine, lauramidopropyl betaine, lauryl of betaine, lauryl hydroxysultaine, lauryl sultaine, milk amidopropyl betaine, milkamidopropyl of betaine, myristamidopropyl betaine, myristyl of betaine, oleamidopropyl betaine, oleamidopropyl hydroxysultaine, oleyl of betaine, olivamidopropyl of betaine, palmamidopropyl betaine, palmitamidopropyl betaine, palmitoyl carnitine, palm kernel amidopropyl betaine, polytetrafluoroethylene acetoxypropyl of betaine, ricinoleamidopropyl betaine, sesamidopropyl betaine, soyamidopropyl betaine, stearamidopropyl betaine, stearyl of betaine, tallowamidopropyl betaine, tallowamidopropyl hydroxysultaine, tallow of betaine, tallow dihydroxyethyl of betaine, undecylenamidopropyl betaine and wheat germ amidopropyl betaine. Preferred betaine is for example cocoamidopropyl betaine.

### Cationic Surfactant

In the preferred embodiment wherein the composition is a hand dishwashing detergent composition, the cationic surfactant is present in an effective amount, more preferably from about 0.1% to about 20%, by weight of the hand dishwashing detergent composition. Suitable cationic surfactant is quaternary ammonium surfactant. Suitable quaternary ammonium surfactant is selected from the group consisting of a mono C₆-C₁₆, preferably a C₆-C₁₀ N-alkyl or an alkenyl ammonium surfactant or a mixture thereof, wherein the remaining N positions are substituted by a methyl, a hydroxyethyl or a hydroxypropyl group. Another preferred cationic surfactant is a C₆-C₁₈ alkyl or alkenyl ester of a quaternary ammonium alcohol, such as quaternary chlorine ester. More preferably, the cationic surfactant has formula (V):

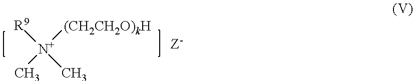

wherein R⁹ of formula (V) is a C₈-C₁₈ hydrocarbyl or a mixture thereof, preferably, a C₈₋₁₄ alkyl, more preferably, a C₈, C₁₀ or C₁₂ alkyl; and Z of formula (V) is an anion, preferably, a chloride or a bromide.

### Solvent

Solvents are generally used to ensure preferred product quality for dissolution, thickness and aesthetics and to ensure better processing. The composition of the present invention may further comprise a solvent or a mixture thereof, as an optional ingredient. Typically, in the preferred embodiment wherein the composition is a hard surface cleaning composition, the composition may comprise from about 0.1% to about 10%, preferably from about 0.5% to about 5%, and more preferably from about 1% to about 3% by weight of the total composition of a solvent or a mixture thereof. In the preferred embodiment wherein the composition is a hand dishwashing detergent composition, the composition contains from about 0.01% to about 20%, preferably from about 0.5% to about 20%, more preferably from about 1% to about 10% by weight of a solvent.

Suitable solvents herein include C₁-C₅ alcohols according to the formula R¹⁰—OH wherein R¹⁰ is a saturated alkyl group of from about 1 to about 5 carbon atoms, preferably from about 2 to about 4. Suitable alcohols are ethanol, propanol, isopropanol or mixtures thereof. Other suitable alcohols are alkoxylated C₁₋₈ alcohols according to the formula R¹¹-(A_{q})—OH wherein R¹¹ is a alkyl group of from about 1 to about 8 carbon atoms, preferably from about 3 to about 6, and wherein A is an alkoxy group, preferably propoxy and/or ethoxy, and q is an integer of from 1 to 5, preferably from 1 to 2. Suitable alcohols are butoxy propoxy propanol (n-BPP), butoxy propanol (n-BP), butoxyethanol, or mixtures thereof. Suitable alkoxylated aromatic alcohols to be used herein are those according to the formula R¹²—(B)ᵣ—OH wherein R¹² is an alkyl substituted or non-alkyl substituted aryl group of from about 1 to about 20 carbon atoms, preferably from about 2 to about 15, and more preferably from about 2 to about 10, wherein B is an alkoxy grup, preferably a butoxy, propoxy and/or ethoxy, and r is an integer of from 1 to 5, preferably from 1 to 2. A suitable aromatic alcohol to be used herein is benzyl alcohol. Suitable alkoxylated aromatic alcohol is benzylethanol and or benzylpropanol. Other suitable solvent includes butyl diglycolether, benzylalcohol, propoxypropoxypropanol (EP 0 859 044) ether and diether, glycol, alkoxylated glycol, C₆-C₁₆ glycol ether, alkoxylated aromatic alcohol, aromatic alcohol, aliphatic branched alcohol, alkoxylated aliphatic branched alcohol, alkoxylated linear C₁-C₅ alcohol, linear C₁-C₅ alcohol, amine, C₈-C₁₄ alkyl and cycloalkyl hydrocarbon and halohydrocarbon, and mixtures thereof.

### Perfume

The composition of the present invention may comprise a perfume ingredient, or mixtures thereof, in amount up to about 5.0% by weight of the total composition, preferably in amount of about 0.1% to about 1.5%. Suitable perfume compounds and compositions for use herein are for example those described in EP-A-0 957 156 under the paragraph entitled “Perfume”, on page 13.

### Dye

The composition according to the present invention may be colored. Accordingly, it may comprise a dye or a mixture thereof. Suitable dyes for use herein are acid-stable dyes. By “acid-stable”, it is meant herein a compound which is chemically and physically stable in the acidic environment of the composition herein.

### pH Adjustment Agent

### Alkaline Material

Preferably, an alkaline material may be present to trim the pH and/or maintain the pH of the composition according to the present invention. The amount of alkaline material is of from about 0.001% to about 20%, preferably from about 0.01% to about 10%, and more preferably from about 0.05% to about 3% by weight of the composition.

Examples of the alkaline material are sodium hydroxide, potassium hydroxide and/or lithium hydroxide, and/or the alkali metal oxide, such as sodium and/or potassium oxide, or mixtures thereof. Preferably, the source of alkalinity is sodium hydroxide or potassium hydroxide, preferably sodium hydroxide.

### Acid

The composition of the present invention may comprise an acid. Any acid known to those skilled in the art may be used herein. Typically the composition herein may comprise up to about 20%, preferably from about 0.1% to about 10%, more preferably from about 0.1% to about 5%, even more preferably from about 0.1% to about 3%, by weight of the total composition of an acid.

Suitable acids are selected from the group consisting of a mono- and poly-carboxylic acid or a mixture thereof; a percarboxylic acid or a mixture thereof; a substituted carboxylic acid or a mixture thereof; and mixtures thereof. Carboxylic acids useful herein include C₁₋₆ linear or at least about 3 carbon containing cyclic acids. The linear or cyclic carbon-containing chain of the carboxylic acid may be substituted with a substituent group selected from the group consisting of hydroxyl, ester, ether, aliphatic groups having from about 1 to about 6, more preferably from about 1 to about 4 carbon atoms, and mixtures thereof.

Suitable mono- and poly-carboxylic acids are selected from the group consisting of citric acid, lactic acid, ascorbic acid, isoascorbic acid, tartaric acid, formic acid, maleic acid, malic acid, malonic acid, propionic acid, acetic acid, dehydroacetic acid, benzoic acid, hydroxy benzoic acid, and mixtures thereof.

Suitable percarboxylic acids are selected from the group consisting of peracetic acid, percarbonic acid, perboric acid, and mixtures thereof.

Suitable substituted carboxylic acids are selected from the group consisting of an amino acid or a mixture thereof; a halogenated carboxylic acid or a mixture thereof; and mixtures thereof.

Preferred acids for use herein are selected from the group consisting of lactic acid, citric acid, and ascorbic acid and mixtures thereof. More preferred acids for use herein are selected from the group consisting of lactic acid and citric acid and mixtures thereof. An even more preferred acid for use herein is lactic acid.

Suitable acids are commercially available from JBL, T&L, or Sigma. Lactic acid is commercially available from Sigma and Purac.

### Salt

In a preferred embodiment, the composition of the present invention also comprises other salts as the pH buffer. Salts are generally present at an active level of from about 0.01% to about 5%, preferably from about 0.015% to about 3%, more preferably from about 0.025% to about 2.0%, by weight of the composition.

When salts are included, the ions can be selected from magnesium, sodium, potassium, calcium, and/or magnesium, and preferably from sodium and magnesium, and are added as a hydroxide, chloride, acetate, sulphate, formate, oxide or nitrate salt to the composition of the present invention.

### Diamine

In another preferred embodiment, the composition of the present invention comprises a diamine or a mixture thereof as the pH buffer. The composition will preferably contain from about 0% to about 15%, preferably from about 0.1% to about 15%, preferably from about 0.2% to about 10%, more preferably from about 0.25% to about 6%, more preferably from about 0.5% to about 1.5% by weight of the total composition of at least one diamine.

Preferred organic diamines are those in which pK₁ and pK₂ are in the range of from about 8.0 to about 11.5, preferably in the range of from about 8.4 to about 11, even more preferably from about 8.6 to about 10.75. Preferred materials include 1,3-bis(methylamine) cyclohexane (pKa=from about 10 to about 10.5), 1,3-propane diamine (pK₁=10.5; pK₂=8.8), 1,6-hexane diamine (pK₁=11; pK₂=10), 1,3-pentane diamine (DYTEK EP®)) (pK₁=10.5; pK₂=8.9), 2-methyl-1,5-pentane diamine (DYTEK A®) (pK₁=11.2; pK₂=10.0). Other preferred materials include primary/primary diamines with alkylene spacers ranging from C₄ to C₈. In general, it is believed that primary diamines are preferred over secondary and tertiary diamines. pKa is used herein in the same manner as is commonly known to people skilled in the art of chemistry: in an all-aqueous solution at 25° C. and for an ionic strength between about 0.1 to about 0.5 M. values. Reference can be obtained from literature, such as from “Critical Stability Constants: Volume 2, Amines” by Smith and Martel, Plenum Press, NY and London, 1975.

### Cleaning Polymer

Preferably, the composition of the present invention can further comprise one or more alkoxylated polyethyleneimine polymers. The composition may comprise from about 0.01% to about 10%, preferably from about 0.01% to about 2%, more preferably from about 0.1% to about 1.5%, even more preferable from about 0.2% to about 1.5% by weight of the total composition of an alkoxylated polyethyleneimine polymer as described on page 2, line 33 to page 5, line 5 and exemplified in examples 1 to 4 at pages 5 to 7 of WO2007/135645 published by The Procter & Gamble Company.

The alkoxylated polyethyleneimine polymer of the present composition has a polyethyleneimine backbone having from about 400 to about 10000 weight average molecular weight, preferably from about 400 to about 7000 weight average molecular weight, alternatively from about 3000 to about 7000 weight average molecular weight.

These polyamines can be prepared for example, by polymerizing ethyleneimine in the presence of a catalyst such as a carbon dioxide, a sodium bisulfite, a sulfuric acid, a hydrogen peroxide, a hydrochloric acid, an acetic acid, and the like.

The alkoxylation of the polyethyleneimine backbone includes: (1) about one or two alkoxylation modifications per nitrogen atom, depending on whether the modification occurs at an internal nitrogen atom or at a terminal nitrogen atom, in the polyethyleneimine backbone, the alkoxylation modification consisting of the replacement of a hydrogen atom on a polyalkoxylene chain having an average of about 1 to about 40 alkoxy moieties per modification, wherein the terminal alkoxy moiety of the alkoxylation modification is capped with a hydrogen, a C₁-C₄ alkyl or mixtures thereof; (2) a substitution of about one C₁-C₄ alkyl moiety or benzyl moiety and about one or two alkoxylation modifications per nitrogen atom, depending on whether the substitution occurs at an internal nitrogen atom or at a terminal nitrogen atom, in the polyethyleneimine backbone, the alkoxylation modification consisting of the replacement of a hydrogen atom by a polyalkoxylene chain having an average of about 1 to about 40 alkoxy moieties per modification wherein the terminal alkoxy moiety is capped with a hydrogen, a C₁-C₄ alkyl or mixtures thereof; or (3) a combination thereof.

### Chelant

It has been found that the addition of a chelant in the composition of the present invention provides an unexpected improvement in terms of its cleaning capability. In a preferred embodiment, the composition of the present invention may comprise a chelant at a level of from about 0.1% to about 20%, preferably from about 0.2% to about 5%, more preferably from about 0.2% to about 3% by weight of total composition.

Suitable chelants can be selected from the group consisting of an amino carboxylate or a mixture thereof; an amino phosphonate or a mixture thereof; a polyfunctionally-substituted aromatic chelant or a mixture thereof; and mixtures thereof.

Preferred chelants for use herein are the amino acid based chelants, and preferably glutamic-N,N-diacetic acid (GLDA) and derivatives, and/or phosphonate based chelants, and preferably diethylenetriamine pentamethylphosphonic acid. GLDA (salts and derivatives thereof) is especially preferred according to the invention, with the tetrasodium salt thereof being especially preferred.

Also preferred are amino carboxylates including ethylenediaminetetra-acetate, N-hydroxyethylethylenediaminetriacetate, nitrilo-triacetate, ethylenediamine tetrapro-prionate, triethylenetetraaminehexacetate, diethylenetriaminepentaacetate, ethanoldi-glycine; and alkali metal, ammonium, and substituted ammonium salts thereof; and mixtures thereof; as well as MGDA (methyl-glycine-diacetic acid), and salts and derivatives thereof;

Other chelants include homopolymers and copolymers of polycarboxylic acids and their partially or completely neutralized salts, monomeric polycarboxylic acids and hydroxycarboxylic acids and their salts. Preferred salts of the above-mentioned compounds are the ammonium and/or alkali metal salts, i.e. the lithium, sodium, and potassium salts, and particularly preferred salts are the sodium salts.

Suitable polycarboxylic acids are acyclic, alicyclic, heterocyclic and aromatic carboxylic acids, in which case they contain at least about two carboxyl groups which are in each case separated from one another by, preferably, no more than about two carbon atoms. Polycarboxylates which comprise two carboxyl groups include, for example, water-soluble salts of, malonic acid, (ethyl enedioxy) diacetic acid, maleic acid, diglycolic acid, tartaric acid, tartronic acid and fumaric acid. Polycarboxylates which contain three carboxyl groups include, for example, water-soluble citrate. Correspondingly, a suitable hydroxycarboxylic acid is, for example, citric acid. Another suitable polycarboxylic acid is the homopolymer of acrylic acid. Preferred are the polycarboxylates end capped with sulfonates.

Further suitable polycarboxylates chelants for use herein include acetic acid, succinic acid, formic acid; all preferably in the form of a water-soluble salt. Other suitable polycarboxylates are oxodisuccinates, carboxymethyloxysuccinate and mixtures of tartrate monosuccinic and tartrate disuccinic acid such as described in U.S. Pat. No. 4,663,071.

Amino phosphonates are also suitable for use as chelant and include ethylenediaminetetrakis (methylenephosphonates) as DEQUEST. Preferably, these amino phosphonates do not contain alkyl or alkenyl groups with more than about 6 carbon atoms.

Polyfunctionally-substituted aromatic chelants are also useful in the composition herein, such as described in U.S. Pat. No. 3,812,044. Preferred compounds of this type in acid form are dihydroxydisulfobenzenes such as 1,2-dihydroxy-3,5-disulfobenzene.

### Hydrotrope

The composition of the present invention may optionally comprise a hydrotrope in an effective amount so that the composition is appropriately compatible in water. The composition of the present invention typically comprises from about 0% to about 15% by weight of the total composition of a hydrotropic, or mixtures thereof, preferably from about 1% to about 10%, most preferably from about 3% to about 6%. Suitable hydrotropes for use herein include anionic-type hydrotropes, particularly sodium, potassium, and ammonium xylene sulphonate, sodium, potassium and ammonium toluene sulphonate, sodium potassium and ammonium cumene sulphonate, and mixtures thereof, and related compounds, as disclosed in U.S. Pat. No. 3,915,903.

### Polymeric Suds Stabilizer

The composition of the present invention may optionally contain a polymeric suds stabilizer. These polymeric suds stabilizers provide extended suds volume and suds duration of the composition. The composition preferably contains from about 0.01% to about 15%, preferably from about 0.05% to about 10%, more preferably from about 0.1% to about 5%, by weight of the total composition of the polymeric suds booster/stabilizer.

These polymeric suds stabilizers may be selected from homopolymers of a (N,N-dialkylamino) alkyl ester and a (N,N-dialkylamino) alkyl acrylate ester. The weight average molecular weight of the polymeric suds booster, determined via conventional gel permeation chromatography, is from about 1,000 to about 2,000,000, preferably from about 5,000 to about 1,000,000, more preferably from about 10,000 to about 750,000, more preferably from about 20,000 to about 500,000, even more preferably from about 35,000 to about 200,000. The polymeric suds stabilizer can optionally be present in the form of a salt, either an inorganic or organic salt, for example the citrate, sulphate, or nitrate salt of (N,N-dimethylamino)alkyl acrylate ester.

One preferred polymeric suds stabilizer is (N,N-dimethylamino)alkyl acrylate ester, namely the acrylate ester represented by the formula (VII):

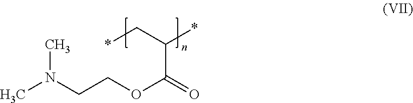

Other preferred suds boosting polymers are copolymers of hydroxypropylacrylate/dimethyl aminoethylmethacrylate (copolymer of HPA/DMAM), represented by the formulae VIII and IX

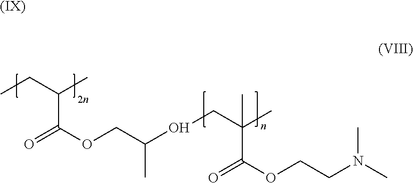

Another preferred class of polymeric suds booster polymers are hydrophobically modified cellulosic polymers having a weight average molecular weight (M_{w}) below about 45,000; preferably between about 10,000 and about 40,000; more preferably between about 13,000 and about 25,000. The hydrophobically modified cellulosic polymers include water soluble cellulose ether derivatives, such as nonionic and cationic cellulose derivatives. Preferred cellulose derivatives include methylcellulose, hydroxypropyl methylcellulose, hydroxyethyl methylcellulose, and mixtures thereof.

### EXAMPLES

These following compositions were made comprising the listed ingredients in the listed proportions (weight %). The examples herein are meant to exemplify the present invention but are not necessarily used to limit or otherwise define the scope of the present invention. Example compositions 1a and 14a are comparative examples.

### Hand Dishwashing Detergent composition Examples and Technical Data

| Examples | | | | | | |
|---|---|---|---|---|---|---|
| (% w/w) | 1 | la | 2 | 3 | 4 | 5 |
| Alkyl ethoxy | 28.0 | 28.0 | 28.0 | 25.0 | 27.0 | 20.0 |
| sulfate AEₓS* | | | | | | |
| Amine oxide | 7.0 | 7.0 | 7.0 | 7.0 | 5.0 | 5.0 |
| C₉₋₁₁ EO₈ | — | — | — | — | 3.0 | 5.0 |
| Ethylan 1008 ® | — | — | — | 3.0 | — | — |
| Lutensol ® TO 7 | — | — | — | — | — | 5.0 |
| GLDA¹ | — | — | — | — | — | 1.0 |
| DTPMP² | — | — | — | — | — | 0.5 |
| DTPA³ | — | — | — | 1.0 | — | — |
| MGDA⁴ | — | — | — | — | 1.0 | — |
| Sodium citrate | — | — | — | 1.0 | — | 0.5 |
| Solvent | 2.5 | 2.5 | 2.5 | 4.0 | 3.0 | 2.0 |
| Polypropylene | 1.0 | 1.0 | 1.0 | 0.5 | 1.0 | — |
| glycol | | | | | | |
| (Mₙ = 2000) | | | | | | |
| Sodium chloride | 0.5 | 0.5 | 0.5 | 1.0 | 1.0 | 0.5 |
| PEG-VAc | 0.1 | — | 0.2 | 0.1 | 0.1 | 0.5 |
| copolymer (40% | | | | | | |
| Ethylene Oxide, | | | | | | |
| 60% Vinyl | | | | | | |
| Acetate, | | | | | | |
| M_{W} = 20,000) | | | | | | |
| Water | to balance | to balance | to balance | to balance | to balance | to balance |

| Examples | | | | |
|---|---|---|---|---|
| (% w/w) | 6 | 7 | 8 | 9 |
| Alkyl ethoxy | 13 | 16 | 17 | 15 |
| sulfate AEₓS* | | | | |
| Amine oxide | 4.5 | 5.5 | 6.0 | 5.0 |
| C₉₋₁₁ EO₈ | — | 2.0 | — | 5 |
| Ethylan 1008 ® | — | 2.0 | — | — |
| Lutensol ® TO 7 | 4 | — | 5 | — |
| GLDA¹ | 0.7 | 0.4 | 0.7 | 0.7 |
| DTPMP² | — | 0.3 | — | — |
| Sodium citrate | — | — | 0.2 | — |
| Solvent | 2.0 | 2.0 | 2.0 | 1.0 |
| Polypropylene | 0.5 | 0.3 | 0.5 | 0.4 |
| glycol | | | | |
| (Mₙ = 2000) | | | | |
| Sodium chloride | 0.5 | 0.8 | 0.4 | 0.5 |
| PEG-VAc | 0.1 | 0.4 | 0.1 | 0.2 |
| copolymer (50% | | | | |
| Ethylene Oxide; | | | | |
| 50% Vinyl | | | | |
| Acetate, | | | | |
| M_{W} = 20,000) | | | | |
| Water | to balance | to balance | to balance | to balance |
| Examples | | | | |
| (% w/w) | 10 | 11 | 12 | 13 |
| Alkyl ethoxy | 16 | 29 | 18 | 20 |
| sulfate AEₓS* | | | | |
| Amine oxide | 5.0 | 7.0 | 6.0 | 6.5 |
| C₉₋₁₁ EO₈ | 5 | — | — | 6.5 |
| Ethylan 1008 ® | — | — | — | — |
| Lutensol ® TO 7 | — | — | — | — |
| GLDA¹ | 0.7 | — | — | 1.0 |
| DTPMP² | — | — | — | — |
| Sodium citrate | — | — | 2.5 | — |
| Solvent | 1.3 | 4.0 | — | 2.0 |
| Polypropylene | 0.5 | 1.0 | 1.0 | 0.4 |
| glycol | | | | |
| (Mₙ = 2000) | | | | |
| Sodium chloride | 0.8 | 1.5 | 0.5 | 0.5 |
| PEG-VAc | 0.1 | 0.4 | 0.1 | 0.2 |
| copolymer (40% | | | | |
| Ethylene Oxide; | | | | |
| 60% Vinyl | | | | |
| Acetate, | | | | |
| M_{W} = 20,000) | | | | |
| Water | to balance | to balance | to balance | to balance |

*Number of carbon atoms in the alkyl chain is between 12 and 13; and x is between 0.5 and 2.
Ethylan 1008 ® is a nonionic surfactant based on a synthetic primary alcohol, commercially available from AkzoNobel.
Lutensol ® TO 7 is nonionic surfactant made from a saturated iso-C₁₃ alcohol.
Solvent is ethanol.
Amine oxide is coconut dimethyl amine oxide.
PEG-VAc copolymer is an amphiphilic graft polymer according to the present invention, commercially available under the trade name Sokalan ® HP22 from BASF.
¹Glutamic-N,N-diacetic acid
²Diethylenetriamine penta methylphosphonic acid
³Diethylenetriamine pentaacetic acid
⁴Methyl glycinediacetic acid
**Examples may have other optional ingredients such as dyes, opacifiers, perfumes, preservatives, hydrotropes, processing aids, salts, stabilizers, etc.

The formulation corresponding to Example 1 is diluted with tap water (water hardness: 15 gpg, temperature: 40° C.) in order to obtain a 10% solution of the original formulation. This solution is applied by a sponge to 3 drinking glasses, which are then rinsed for 10 seconds under running water (water hardness: 15 gpg; temperature: 40° C.). The glasses are stored vertically after rinsing and allowed to dry at ambient temperature (20° C.). The drying time is recorded from immediately after rinsing up to the first moment the glasses are completely dry (no visible water droplets left). After drying, the glasses are graded visually by two judges for shine on a 0 to 6 point scale (0=complete absence of streaks; 6=extremely bad streaks). The same procedure is followed for the formulation corresponding to Comparative example 1a and to Example 2. Results are reported in the following table:

| | Shine Grading |
|---|---|
| | (average of 3 glasses/2 judges) |
| Example 1 | 1 |
| Comparative example 1a | 2.5 |
| Example 2 | 1.5 |

### Hard Surface Cleaning composition Examples and Technical Data

| | Examples | | | | |
|---|---|---|---|---|---|
| | 14 | 14a | 15 | 16 | 17 |
| | (% w/w) | (% w/w) | (% w/w) | (% w/w) | (% w/w) |
| Water | to balance | to balance | to balance | to balance | to balance |
| Nonionic | 4.0 | 4.0 | 3.0 | 5.0 | 3.0 |
| surfactant | | | | | |
| (Poly- | | | | | |
| ethoxylated | | | | | |
| alcohol | | | | | |
| C₉₋₁₁ EO₈) | | | | | |
| C₁₂₋₁₄ Alkyl | — | — | 1.5 | 1 | 2.0 |
| sulphate | | | | | |
| C₁₂₋₁₆ Fatty | 0.35 | 0.35 | 0.5 | — | 0.5 |
| acid | | | | | |
| PEG-VAc | 0.1 | — | 0.1 | 0.2 | 0.15 |
| copolymer | | | | | |
| (40% | | | | | |
| Ethylene | | | | | |
| Oxide; 60% | | | | | |
| Vinyl | | | | | |
| Acetate; | | | | | |
| M_{W} = | | | | | |
| 20,000) | | | | | |
| Chelant | 0.1 | 0.1 | 0.05 | — | — |
| (DTPMP) | | | | | |
| Citric acid | 0.3 | 0.3 | 0.4 | 0.2 | 0.1 |
| Buffering | Up to | Up to | Up to | Up to | Up to |
| agents | pH 10 | pH 10 | pH 10 | pH 10 | pH 10 |
| (NaOH, | | | | | |
| Na₂CO₃) | | | | | |
| Other | 0.5 | 0.5 | 0.6 | 0.5 | 0.6 |
| ingredients | | | | | |
| (Perfume, | | | | | |
| pre- | | | | | |
| servatives) | | | | | |

A kitchen sponge of dimensions 4 cm×4 cm×8 cm is wetted with tap water (water hardness: 15 gpg; temperature: 40° C.) and squeezed in order to obtain a total weight of sponge and water of 35 g.

2 ml of the formulation corresponding to Example 14 is applied on this sponge and the sponge is then manually wiped with constant motion on two black ceramic tiles of dimensions 20 cm×20 cm. The sponge is then thoroughly rinsed under running water and squeezed in order to obtain the same weight as at the beginning (35 g). The rinsed sponge is wiped again on the same tiles in order to remove the detergent solution. The rinsing and wiping operation is repeated three times. The tiles are stored horizontally and allowed to dry at ambient temperature (20° C.). The drying time is recorded from immediately after rinsing up to the first moment the tiles are completely dry (no visible water droplets left). After drying, the two tiles are graded visually by two judges for presence of streaks on a 0 to 6 point scale (0=complete absence of streaks; 6=extremely bad streaks). The same procedure is followed for the formulation corresponding to Comparative example 14a. Results are reported in the following table:

| | Shine Grading | |
|---|---|---|
| | (average of 2 tiles/2 judges) | Drying Time |
| Example 14 | 2 | 1 min 0 sec |
| Comparative example 14a | 4 | 2 min 0 sec |

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method of providing fast drying and/or delivering shine on a hard surface with a composition comprising an amphiphilic graft polymer based on water-soluble polyalkylene oxides as a graft base and side chains formed by polymerization of a vinyl ester component, wherein said amphiphilic graft polymer is water-soluble or water-dispersible and has a weight average molar mass (M_{w}) of from about 3,000 to about 100,000, and wherein said hard surface is selected from the group consisting of a household hard surface; a dish; flatware; glassware; cutlery; and mixtures thereof.

2. A method according to claim 1, wherein said composition is a hard surface cleaning composition.

3. A method according to claim 1, wherein said composition is a hand dishwashing detergent composition.

4. A method according to claim 3, wherein said method is capable of delivering shine on a hard surface.

5. A method according to claim 1, wherein said composition is an automatic dishwashing detergent composition.

6. A method according to claim 2, wherein said composition is aqueous composition comprising from about 70% to about 99% by weight of the total composition of water.

7. A method according to claim 3, wherein said composition is aqueous composition comprising from about 30% to about 95% by weight of the total composition of water.

8. A method according to claim 1, wherein said amphiphilic graft polymer has an average of less than or equal to about one graft site per about 50 alkylene oxide units.

9. A method according to claim 1, wherein said composition comprises from about 0.01% to about 10% by weight of the total composition of said amphiphilic graft polymer.

10. A method according to claim 1, wherein said amphiphilic graft polymer has a polydispersity of less than or equal to about 3.

11. A method according to claim 1, wherein said amphiphilic graft polymer comprises less than or equal to about 10% by weight of the polyvinyl ester in ungrafted form.

12. A method according to claim 1, wherein said amphiphilic graft polymer has
(A) from about 20% to about 70% by weight of a water-soluble polyalkylene oxide as a graft base and
(B) side chains formed by free-radical polymerization of from about 30% to about 80% by weight of a vinyl ester compound composed of
(B1) from about 70% to about 100% by weight of vinyl acetate and/or vinyl propionate and
(B2) from about 0% to about 30% by weight of a further ethylenically unsaturated monomer in the presence of (A).

13. A method according to claim 1, wherein said amphiphilic graft polymer has
(A) from about 30% to about 60% by weight of a water-soluble polyethylene oxide as a graft base and
(B) side chains formed by free-radical polymerization of from about 40% to about 70% by weight of a vinyl ester compound composed of
(B1) from about 70% to about 100% by weight of vinyl acetate and/or vinyl propionate and
(B2) from about 0% to about 30% by weight of a further ethylenically unsaturated monomer in the presence of (A).

14. A method according to claim 1, wherein said composition further comprises from about 1% to about 80% by weight of the total composition of a surfactant or a mixture thereof.

15. A method according to claim 14, wherein said surfactant is selected from the group consisting of an anionic surfactant or a mixture thereof; a nonionic surfactant or a mixture thereof; a cationic surfactant or a mixture thereof; an amphoteric surfactant or a mixture thereof; a zwitterionic surfactant or a mixture thereof; and mixtures thereof.

16. A method according to claim 1, wherein said composition further comprises from about 0.01% to about 20% by weight of the total composition of a solvent.

17. A method according to claim 1, wherein said composition further comprises an additional ingredient selected from the group consisting of an alkaline material or a mixture thereof; an acid or a mixture thereof; a salt or a mixture thereof; a cleaning polymer or a mixture thereof; a chelant or a mixture thereof; a perfume or a mixture thereof; a dye or a mixture thereof; a hydrotrope or a mixture thereof; a polymeric suds stabilizer or a mixture thereof; a diamine or a mixture thereof; and mixtures thereof.

18. A method according to claim 1 wherein said composition is in a form selected from the group consisting of a liquid; a gel; and a solid.

19. A method according to claim 1, wherein said composition is a liquid composition having a pH from about 0.5 to about 14.
